(19) United States
(12) Patent Application Publication
(10) Pub. No.: US 2012/0117537 A1
(43) Pub. Date: May 10, 2012

(54) Flow Chart Programming Platform for Testers and Simulators

(75) Inventors: Dennis Allen Sierk, Huntsville, AL (US); Dustin Donavon Sierk, Huntsville, AL (US)

(73) Assignee: VELOCIO NETWORKS, INC., Huntsville, AL (US)

(21) Appl. No.: 13/284,017

(22) Filed: Oct. 28, 2011

Related U.S. Application Data
(60) Provisional application No. 61/409,256, filed on Nov. 2, 2010.

(51) Int. Cl. G06F 9/44

(52) U.S. Cl. 717/113

(57) ABSTRACT

A system for the development, compilation, execution, monitoring and debug of automated test and simulation systems in a flow chart programming language. A development and debug system, implemented as software on a computer, which provides an application developer the capability to enter fully defined application programs through the use of graphical flow charts. An executions system, implemented as a program on a device incorporating a central processing unit, memory, communications and necessary interfaces, which executes graphical flow charts compiled by the development and debug system. The development and debug system communicates with the execution system to download programs, control operation, monitor operation and provide a debugging environment.

### CROSS-REFERENCE TO RELATED APPLICATIONS

This application claims the benefits of provisional patent application Ser. No. 61/409,256, filed on Nov. 2, 2010 by the present inventor.

### BACKGROUND

1. Prior Art

The following is a tabulation of some prior art that presently appears relevant

U.S. Patents

| Pat. No. | Kind Code | Issue Date | Patentee |
|---|---|---|---|
| 4,852,047 | B1 | July 1989 | Lavalle et al. |
| 6,275,955 | B1 | August 2001 | Klein et al. |
| 6,421,821 | B1 | July 2002 | Lavalle |
| 6,243,857 | B1 | June 2001 | Logan, III et al. |
| 6,754,540 | B1 | June 2004 | McFarland et al. |
| 6,865,729 | B1 | March 2005 | McMillan et al. |
| 7,000,191 | B2 | February 2006 | Schmitt et al. |
| 7,302,676 | B2 | November 2007 | Schmitt et al. |

2. Background

This invention relates to a method for designing, implementing and debugging of automated tests systems, automated simulation systems and similar real time systems. In particular, it relates to application development, programming, debug and monitoring through the use of graphical flow charts.

Automated test systems are designed to put a device or system under test (DUT) through a numbers of operational scenarios, while measuring the system response to determine whether operation is correct and within defined limits. This is sometimes done while putting the DUT under stress, with environmental conditions controlled to simulate realistic operational conditions, particularly extreme conditions. In order for the test to be useful and valid, the exact conditions, sequence and response must be precisely controlled and measurement data recorded in a meaningful format.

Automated simulator systems for personnel training or scenario simulation are intended to provide an operational experience to the trainee or scenario analyst that mimics the actual system. The appearance, feel, operational response and every other detail should be designed and built so precisely similar to the real system that the trainee or analyst gets an accurate representation of real system operation.

The largest problem with current automated test and simulation technology, has to do with software. For a test application to be useful and valid, the system software must drive the test to perform stimulation, measurement, sequence and environmental control exactly as specified. It must also be possible to readily verify the test system is performing as required.

Current systems, designed in high level languages, like ‘C’, C++, Visual Basic or Java tend to be problematic in a number of key areas. System applications, written in such standard high level languages tend to be difficult and time consuming to develop, in addition to being prone to program errors. They yield resulting code that is cryptic to read and very difficult to validate conformance to the original specification. Furthermore, propagating known good test code from application to application ranges from difficult to impossible, given the variability of test platforms.

Test or simulation requirements are typically specified in descriptive terminology, with graphical representation in flow charts. These specification flow charts define precisely how the application is to perform. The first problem comes from trying to translate the definition flow chart into executable code. The second problem is in being able to review the code and clearly determine whether the code actually implements the intended operation. For simple applications, these problems tend not to be severe. As system complexity grows, the problem grows exponentially. For complex system requirements, problems associated with software development and validation lead to significant uncertainty. Uncertainty leads to risk. Risk can translate to performance issues, ranging from minor to catastrophic failure in real application.

As system application requirements become more complex, software development becomes an increasingly significant cost component, and a leading factor in application development time. Translating from clear, typically flow chart defined, specifications to executable code is a time consuming, error prone, difficult to validate process.

This invention defines a solution to the problems, just outlined, through the use of a graphical flow chart creation, debug and execution system. Through the direct application of flow chart programming to automated test and simulation systems, the issues related to translation and implementation in standard high level languages are eliminated or greatly minimized. The monitoring and debug features of the system simplify and allow clear positive validation of operation, according to the specifications. The provision of reusable subroutine capabilities, within the system, improve the overall capability to propagate solutions to future and similar applications.

Prior art exists for the programming of automation systems through the use of graphical flow charts. A number of patents exist related to the application of graphical flow chart programming to automation, particularly with regard to machine control. Some of the earliest application of graphical flow chart programming to the control of machinery was performed by Universal Automation, of Hudson, N.H., which received U.S. Pat. No. 4,852,047. In actual application, Universal Automation developed a number of systems for the control of machinery within General Motors manufacturing facilities. The company was sold to Nematron, Corporation, which through a wholly owned subsidiary, NemaSoft, Inc. continued with the development of the technology, receiving U.S. Pat. No. 6,243,857. Throughout the 1990s, and continuing through the present time, a number of companies, including Think and Do, Entivity, Steeplechase and Phoenix Contact have applied graphical flow chart programming to automation applications. These companies, and others have received a number of patents in this field.

The application of flow chart programming to automation application has been met with moderate success. Flow chart programming is a good tool for such applications. However, another graphical programming technology, graphical ladder logic programming, has been the dominate programming language for many years. Flow chart programming has thus far shown insufficient advantages over the entrenched ladder logic programming technology to displace it in the field of automation.

The application fields of automated test and simulation represent much better natural markets for graphical flow chart programming than does the field of automation. Automated test, by its very nature, is a process and decision based technology. The decision mechanism, of determining whether measured results meet established criteria is central to the purpose of automated test. The flow chart process and decision block structure is directly applicable to this type of operation, whereas other graphical systems, such as ladder logic, are poor representations and not well suited. The same applies to simulation. Simulation is also fundamentally a process and decision application. Graphical flow charts can directly define required system operation, and are commonly used in the specification of such operation. Direct translation to graphical flow chart programming is a natural, efficient and low risk development approach.

### SUMMARY OF THE INVENTION

The purpose of this invention is the creation of a method which provides the user the ability to design, program, monitor and debug automated test and simulation systems through the use of graphical flow charts. The user should be provided a great deal of flexibility and visibility into system programming, monitoring, and debug of system applications. The invention also incorporates a method by which components of the user created program can be isolated and reused in other applications.

According to this invention, the purpose defined above is achieved by carrying out process steps defined in the following list.
a) Preparing a flow chart of the required functional operation of the application.
b) Entering of flow chart elements into a graphical display of a development system, through the selection, placement and detail entry functions provided by the development system.
c) Interconnect the individual flow chart elements in a manner that conforms to the required flow of the flow chart operation.
d) Create subordinate flow charts in the same manner as the main flow charts.
e) Place flow chart blocks, which call subordinate flow charts from the main flow chart, or other subordinate flow charts to provide linkage and program functionality required by the application.
f) Allow the saving of the program charts to a storage mechanism, such as hard disk or electronic memory.
g) Repeating steps b) though f) until the entire application is programmed in graphical flow charts
h) Compile main flow chart and sub charts into either object or pseudo code which is executable by the target execution system.
i) Transfer, or download the compiled code to the target execution system.
j) Enable the application program to either start running in finished, free running mode, or run under the control and monitoring of the development system's debugger.
k) Within the debugging system, monitor operation, view operational data, start and stop, single step the application program, set and clear breakpoints. All of this is performed in graphical, flow chart format.

Through the invention, the user may program, monitor and debug automated test and automated simulation applications. Transition between the program entry and program debug modes is transparent. As a consequence of the method of the invention, the user may edit and debug iteratively, until he or she is satisfied with the application system operation and performance.
The software development environment directly and graphically translates specification flow charts and provides self documentation that clearly demonstrates adherence to the specifications.
The software development environment provides for the development of re-usable software function components that can be directly applied to similar or related applications.
The solution significantly reduces development time, validation time, development and implementation costs.

### DRAWINGS BRIEF DESCRIPTION

FIG. 1 shows the major components and configuration of a typical automated test or simulation system.

FIG. 2 shows the core minimal set of program flow chart blocks.

FIG. 3 shows an example of a development system used for the entry of the main flow chart for a test application program.

FIG. 4 shows an example of a development system used for the entry of a flow chart subroutine.

FIG. 5 shows the application of the debug function.

FIG. 6 shows a flow chart of the high level logic design of the development and debug system.

FIG. 7 shows a flow chart of the logic of the flow chart build subsystem of the development and debug system.

FIG. 8 shows a flow chart of the logic of the flow chart debug subsystem of the development and debug system.

FIG. 9 shows a flow chart of the high level operation of the target test or simulation system.

FIG. 10 shows a flow chart of the logic execution engine subsystem of the target test or simulation system.

FIG. 11 shows a flow chart of the logic execution detail subsystem of the target test or simulation system. This is a function component of the flow chart logic illustrated in FIG. 10.

### DETAILED DESCRIPTION

### Conceptual Overview

The concept for a design environment and execution platform that provides for the design, construction and programming of testers and simulators in efficient, reliable, low risk manner is outlined in the following text.

The graphical software programming solution:
provides for application programming in a graphical, flow chart development language
provides for debugging of application code from the development module.
provides for the permanent deployment of finalized executable code to the execution platform.
provides an architecture that easily enables the development of standard algorithms that can be reused.

With these software features, the major problems associated with current software technology can be eliminated. Systems built with the embodiment of this technology provide:
greater efficiency in software development
greatly simplified validation of code, due to the direct implementation of flow chart specifications.
Self documentation of operation
improved debug process
standardization of code and methods.
elimination of a high percentage of application uncertainty.

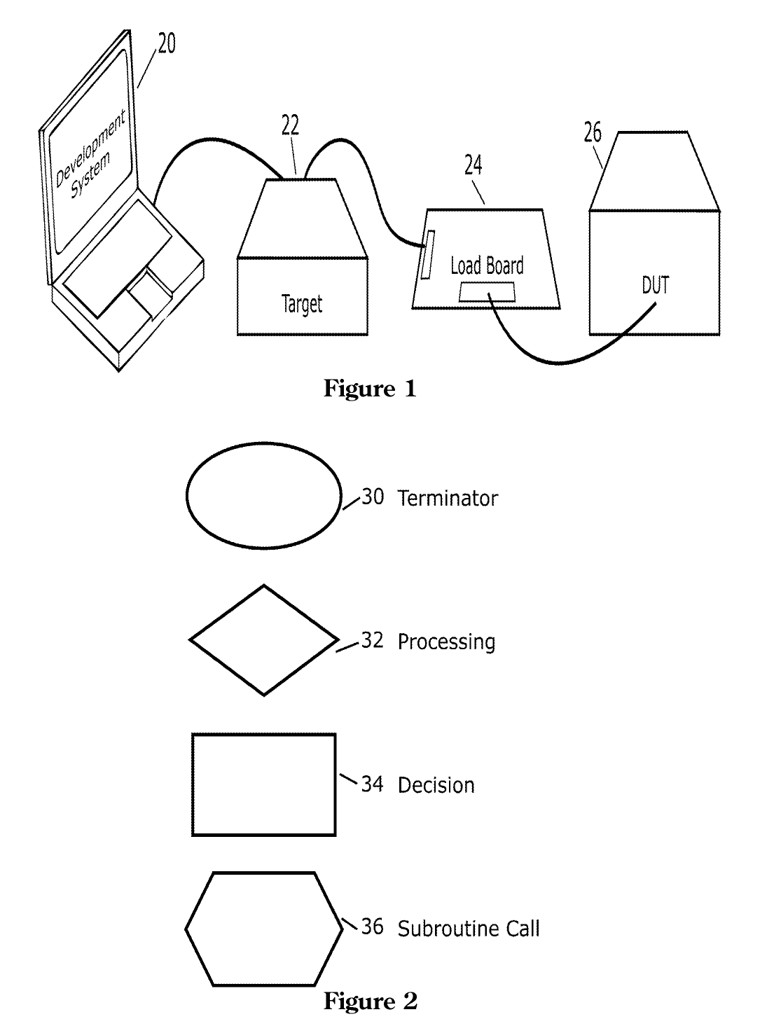

The embodiment of a system of the type described in the following pages and illustrated in FIG. 1, consists of two major system component types. The first major system component type is a development and debug system 20. The second is an execution platform 22. Typically, one development and debug system can support the development of one or more execution platforms.

The development and debug system, simply referred to as development system herein, would typically be embodied by special development software executing on a computer. At the time of this writing, a typical personal or laptop computer would be an appropriate hardware platform for the development system. In actuality, any computer that has graphical display, operator interface and data storage capability would suffice.

The development system is the tool that an application developer uses to write application software. It includes graphical manipulation and display capabilities. The system allows the application developer to select standard graphic flow chart blocks from a selection list, place them in an application appropriate sequence and thereby create a custom flow chart that represents the logic that he or she requires for the performance of the test or simulation application. The second major function of the development system is compilation of the flow chart code to executable form and transfer of the executable code to an execution platform. The third major function of the system is the enablement and control of program debug operations. There are many other details to this process, that are discussed in subsequent pages.

The execution platform 22 is a device with a CPU, memory and real world input/output instrumentation. It may be a computer, including the same computer used for development and debug, with real world input/output interface electronics. It may be an embedded platform that has the necessary characteristics and some mechanism for communicating with the development system.

The execution platform can operate under the control of the development system. It will accept executable code from the development system. It will start and stop program execution on command. It will accept and execute debug instructions, such as single step and breakpoint commands. Once the program is finalized, the execution platform can operate independent of the development system in the execution of the downloaded executable code.

### Flow Chart Programming Overview

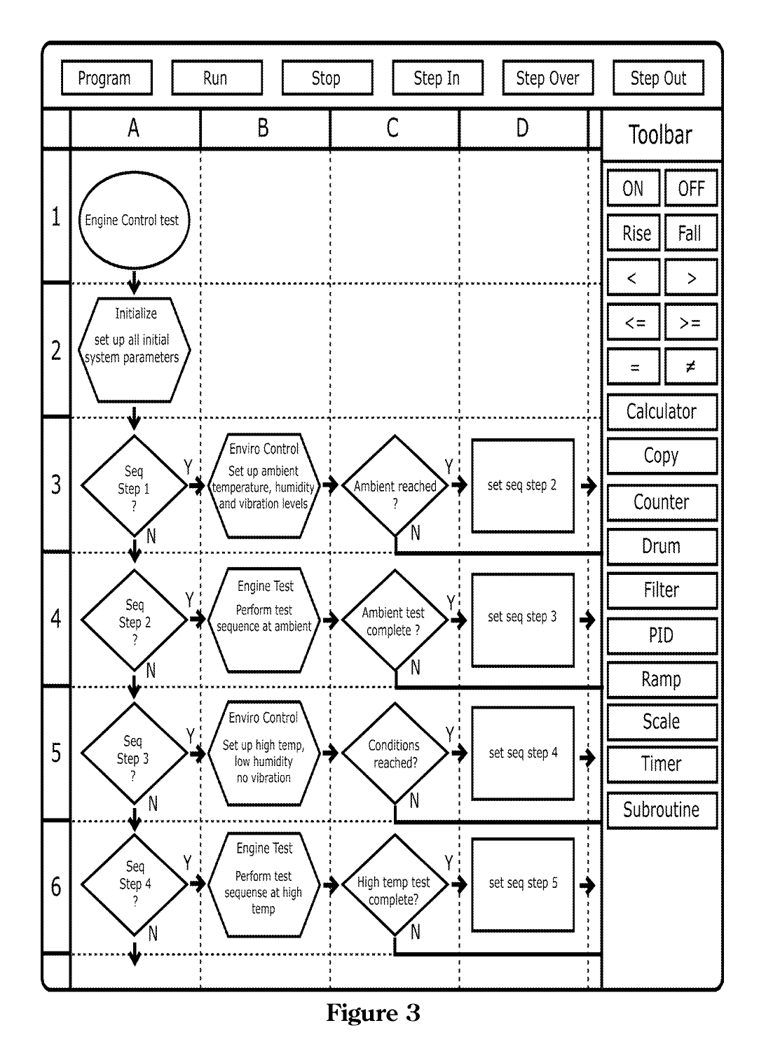

Prior to describing the details of an embodiment of the invention, examination of FIGS. 2, 3 and 4 should provide a clearer concept of what the application environment entails. This should create a greater understanding of the significance of flow chart programming for testers and simulators.

FIG. 2 contains examples of the basic function blocks found in flow charting. Symbol 30 shows a termination block, which indicates the starting or termination point of a program or subroutine. The main program flow chart has a Start termination for the entry point into the program, and possibly an End termination for exit from the program. Each subroutine has a Start termination and one or more Return terminations.

The rectangular symbol 34 is used for processing. Processing can be a mathematical operation, signalling, input/output, or any other type of processing that might occur in an application. Some flow charting systems will utilize a number of different symbols for specific types of processing. However, each symbol simply defines operational processing that has one entry and one exit point.

Symbol 32 is a decision block. Typically, a decision block has one entry point and two or more potential exit points. A decision is made within the decision block as to which exit point to follow. The decision block is a key component of test and simulation systems. A typical use of a decision block in a test system is a decision as to whether the test item passed or failed. A typical use of a decision block in a simulation system is if a particular scenario happened, proceed with one logic path, whereas, if it didn't, proceed with an alternate logic path.

Symbol 36 is a Subroutine Call. It indicates that a subordinate program, defined by its own flow chart, is to be called at the point where the Subroutine Call symbol is shown in the flow chart. Normally associated with a Subroutine Call are a list of parameters that are to be passed to and/or from the subroutine. A parameter that is passed simply as a numeric value, is referred to as pass by data. The subroutine can do anything that it is designed to do with a passed by data parameter, except make a modification to the parameter in the calling program that is the source of the data. A parameter that is passed into a subroutine, and can be modified by the subroutine, is referred to as a Pass by Reference parameter.

While there are other potential flow chart function blocks and while different appearing symbols can be used for the flow chart functions just described, these four symbols form the core of any flow chart. With these four symbols, in combination with connecting lines, it is possible to define the logic and flow of any decision making system.

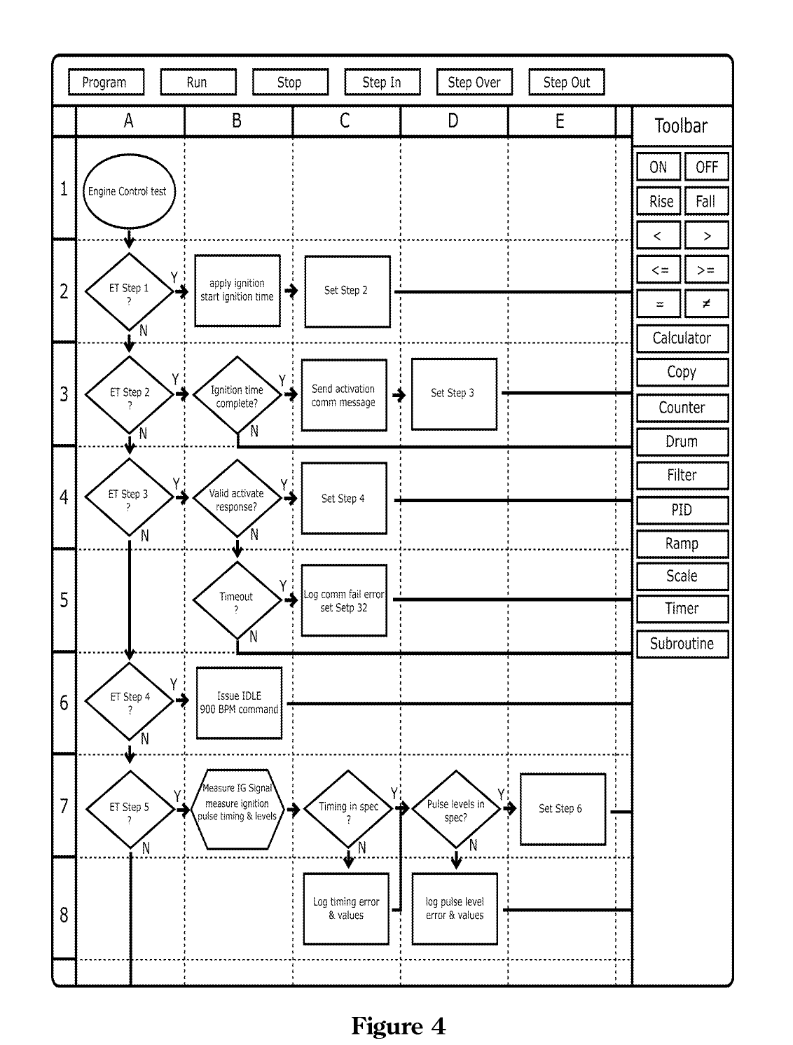

FIGS. 3 and 4 illustrate basic flow chart programming. The flow chart shown in FIG. 3 is part of a typical main program for a test application. It shows a general test sequence, whose details are implemented in subroutine flow charts (or sub-charts). The flow chart shown in FIG. 4 is an example of a typical sub-chart that is called from the main flow chart. The sub-chart performs actual test operations, at a more detailed level. Any chart or sub chart can call any number of subordinate sub charts necessary to fully define the execution of the test or simulation system. This is illustrated as item 40 in FIG. 3.

### Description and Operation

The embodiment of a system for implementing a Flow Chart Platform for Testers and Simulators consists of two primary components. The first component is the Development and Debug System. The second is the Execution Platform. Both of these entities consist of electronic CPU based hardware and associated software.

The Development and Debug System is a computer, with a CPU, memory, storage, operator input devices, a graphical display system, a means to communicate to the Execution Platform and software that implements the logic described in the following text.

The Execution Platform is an entity, controlled by a CPU, which includes memory, a mechanism for storing program and results data, electronic interfaces to the device under test (DUT) or simulation, a means of communications with the Development and Debug System and software or firmware that implements the logic described on the following pages. The Execution Platform may exist as part of the same computer used for development and debug, or it may be a separate device with a communications link. In many embodiments, it may be an embedded system.

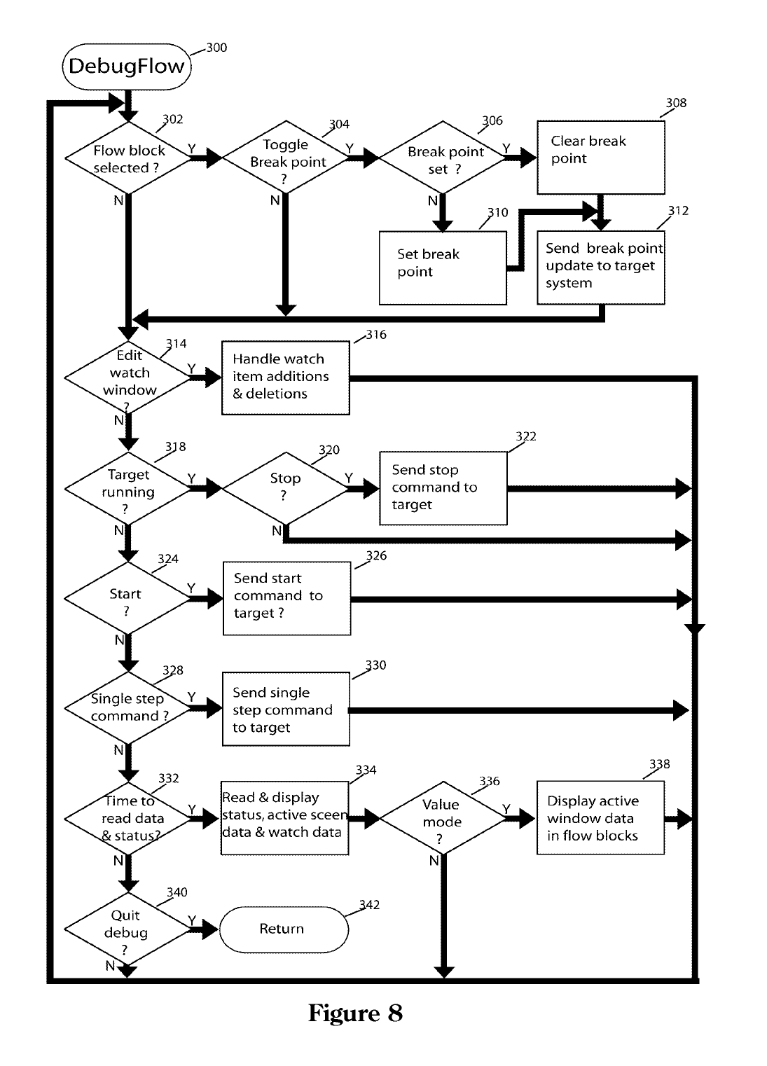

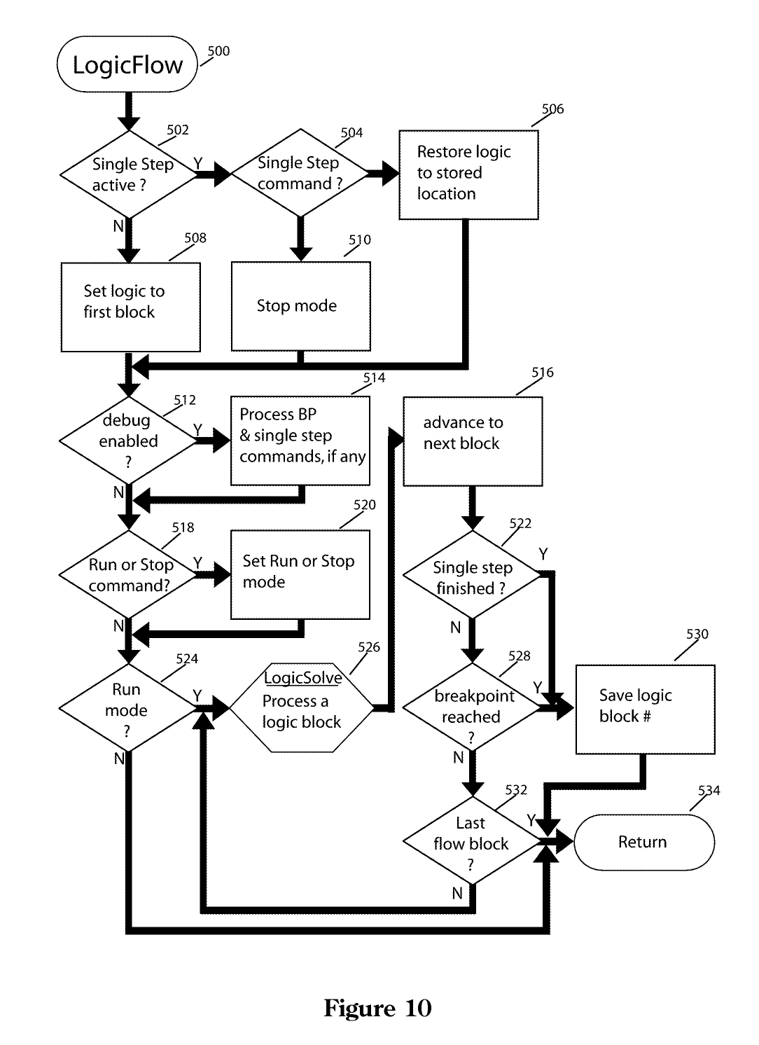

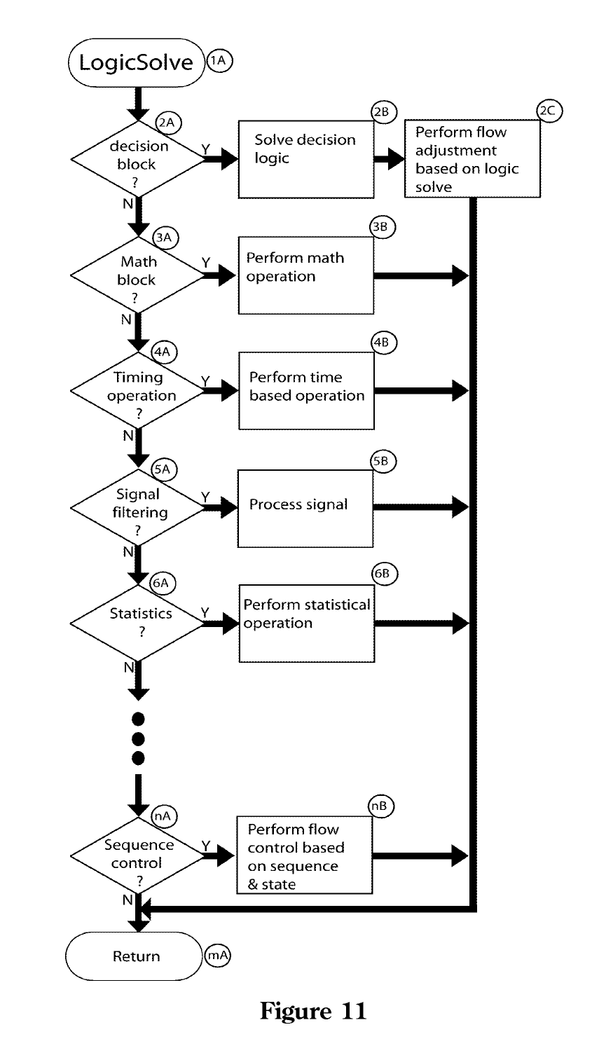

The embodiment of the invention incorporates the interactive functionality of the development and target systems. The functional operation of each of these systems is defined, through the use of flow charts in FIGS. 4 through 11. A review of these flow charts, in relation to the others should clarify the significance and the operation of each. This is particularly true for FIG. 8, labeled DebugFlow, of the development system and FIG. 10, labeled LogicFlow, found in the target system. After exploring the logic of the individual system components, the operation of the system, as a whole, becomes clear.

The flow charts illustrate one embodiment of the functionality of the invention. There are other potential embodiments of the same core concepts. Also, the various logic components are given names in the flow charts and write ups. The names are meant to be indicative of operation. They have no significance beyond the attempt to present clear concepts and may not be the actual function names used in a system design.

### Development and Debug System Operation

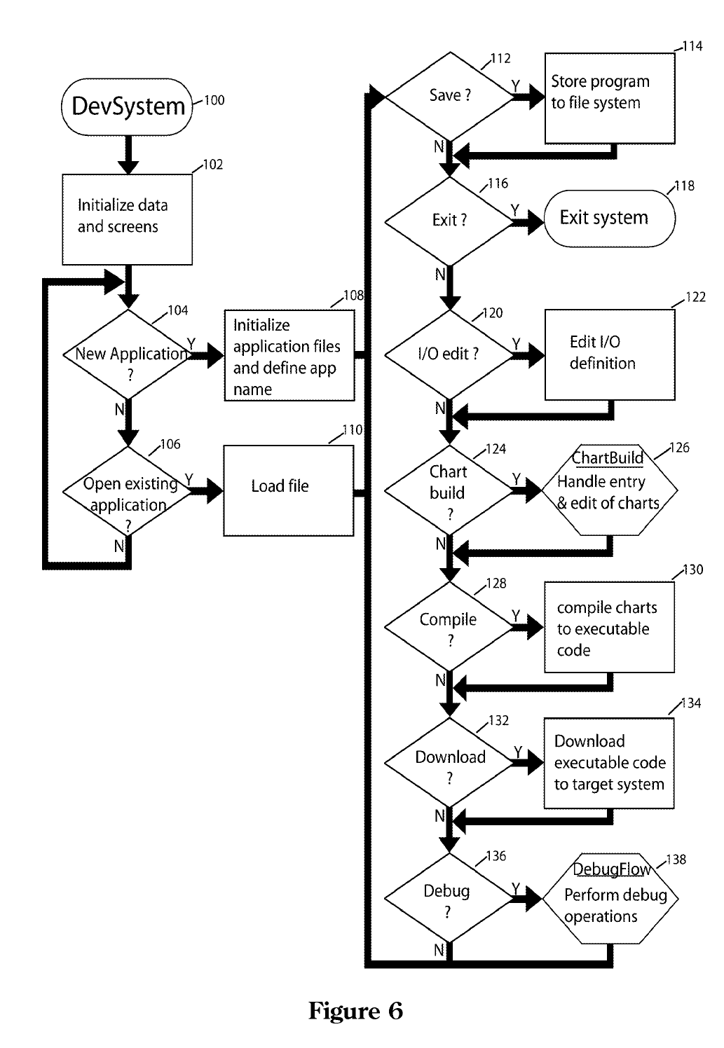

FIG. 6 defines the logic for the main program of the development system. The development system operates as a continuous loop. Start up occurs in block 100, followed by initialization and set up of the system GUI, shown in 102. Next, in blocks 104 and 106, the user is allowed to select the creation of a new application, or the loading of an existing, saved application. If a new application is desired, decision block 104 will direct program flow to function block 108, which will initialize the data and graphics for the entry of a new program.

If the user selects opening an exiting application, decision block 106 will direct program flow to the file load operation found in block 110.

Once, either a new application is initialized, or a stored application is loaded, the program goes into a loop. Within this loop, the application developer can chose to edit input/output (I/O) definitions, enter flow charts and sub-charts, compile the program into executable code, download to a target system, perform debug operations, save the application, or exit the development system.

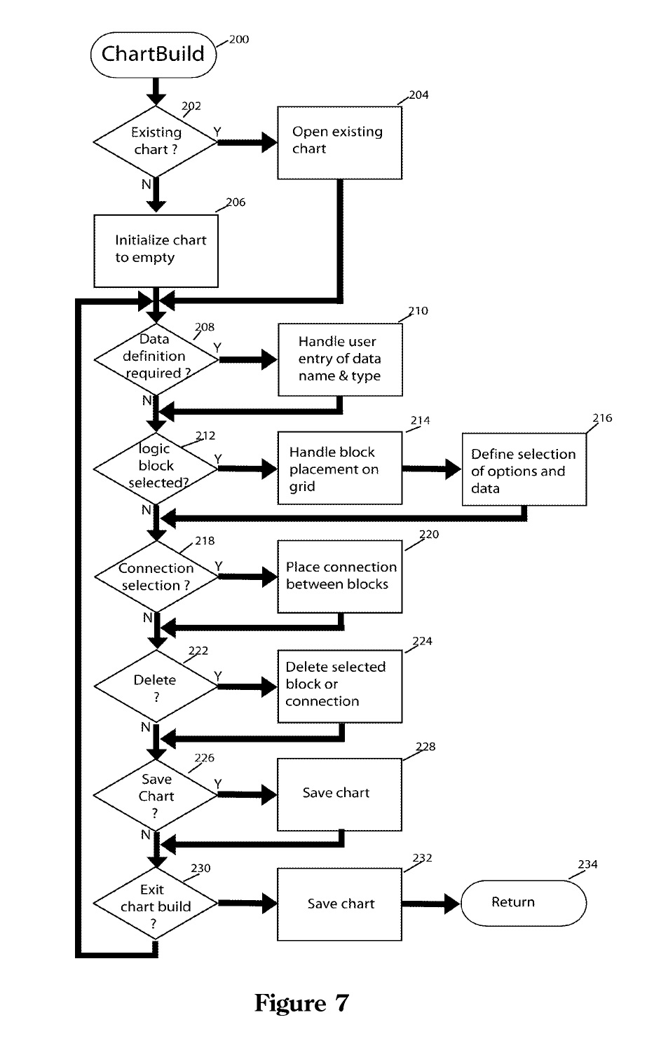

Each of the available options are defined on the system flow chart. The options and their decision/execution are listed below.
Any time the application developer chooses to save the program, as it currently exits, decision block 112 and processing block 114 will detect the selection and execute the program save. The development system operational flow returns to the main loop, which enables the developer to proceed with other operations following the save.
If the developer selects exit from the system, decision block 116 and exit block 118 perform an orderly system exit.
If the developer selects to edit the input/output definition for the system, decision block 120 detects the selection and process block 122 handles the editing of the I/O. The development system operational flow returns to the main loop, which enables the developer to proceed with other operations following this operation.
If the developer selects the entry or editing of a flow chart or sub chart, decision block 124 detects the selection and direct program flow to the chart building operation, shown in 126. The ChartBuild is a detailed in FIG. 7.
If the developer makes the selection to compile the application flow charts into executable code, decision block 128 and processing block 130 handle this operation.
When the developer selects the downloading of compiled, executable code to the target system, decision block 132 and processing block 134 handle that selection.
When debug is selected, decision block 136 directs program flow to the operation shown as subroutine DebugFlow in block 138. Debug Flow is separately detailed in FIG. 8.

Altogether, the decisions, operations and program flow illustrated in FIG. 6 depict the high level functional operation of the Development and Debug System of the Flow Chart Programming Platform for Testers and Simulators.

### Chart Build Function of the Development and Debug System

FIG. 7 defines the ChartBuild logic and processing of the Development and Debug system.

When chart building is selected from the Development and Debug System main program, logic flow enters the ChartBuild function at block 200.

The program logic allows the application developer to select a pre-existing, saved flow chart, or select to start a new chart. The logic for that decision is shown as block 202, with the program flow to either block 204, or block 206, based on the selection.

After the chart has been selected or a new one has been initialized, ChartBuild program flow enters a loop that continues until the developer chooses to exit ChartBuild. That decision logic and processing are shown in blocks 230, 232 and 234. The user selection to exit the ChartBuild is detected by the decision logic illustrated as block 230. Once exit is selected, the chart is saved 232 and program flow returns to the main program 234.

As shown in FIG. 7, the ChartBuild function coordinates the developer controlled building and editing of program logic, using graphical flow chart blocks and connectivity.

During the development of the flow chart program, program variables need to be defined and edited. Flow chart block 212 illustrates the logic involved with a user selection to enter or edit program data. Once the selection to perform data entry or editing is made, logic block 216 enables the block entry placement 214 and entry of the desired data definitions.

The core of the user's application program logic is expressed in function blocks. Chart development allows the application developer to chose standard function blocks and place them on the program flow chart, typically through a drag and drop operation. The program block provides standard logic capability that must be customized through user configuration. Examples of block configuration requirements are listed below and illustrated in FIG. 3.
A mathematics processing block 62 allows the entry of the equation to be processed.
A timer block 78 allows the selection of the timer. It allows the selection of the type of time operation, such as operate on time out, or operate for time duration. It may also allow the selection of reset or restart conditions.
A filtering block 70 allows the entry of parameters that define the filtering. Such parameters may include scaling factors, definition of the number of historical measurements to apply to the filter, limits, and mathematical definitions.
A decision block, 42 through 60, allow the entry of decision criteria. Examples of possible decision criteria include the following.
The state of a selected parameter, 42, 44, 46 and 48
The value of a variable, 52 through 60
Time, 52 though 60
A program sequence number, 52 though 60
A message, 58 and 60
Combinations of any set of decision criteria
A sub-chart call allows the selection of the sub-chart to be called. The sub-chart call 80 includes the definition of any data to be transferred to and from the sub-chart and other data to which the subroutine is to have access.
A file access block allows the definition of the file to be access, as well as the data transfer details.
Special function, such as PID (Peripheral Integral Derivative processing) 72, sequencers, statistical processing blocks and logical operators all allow the entry of definition selections and parameters that allow clear definition of the operation of the logic block
Exit and return block are the only standard blocks that typically require no configuration.

When the developer selects a function block to be placed on the flow chart grid, shown in FIG. 7 as block 212, the ChartBuild function handles the drag and drop operation of placing the block, shown as block 214. Once the block is in place, a mechanism for configuring the appropriate block parameters becomes available. That selection of options and data is shown in block 216.

For a flow chart program to be clearly defined, program flow from one block to another must be clearly delineated. The logic shown in blocks 218 and 220 allows the application developer to select the placement of connections between program blocks. The end result must be a flow chart exemplified by the examples shown in FIGS. 3 and 4. All charts must have an entry point. Every chart, except the main flow chart must have a return. Every processing block, special function block and sub-chart must have and entry and an exit connection. Every decision block must have an entry connection and two or more exit connections, as defined by the block.

The other major logic function of the ChartBuild function is the logic associated with deletion of any block or connection. That logic is shown as flow chart blocks 222 and 224.

### DebugFlow Function of the Development and Debug System

FIG. 8 defines the DebugFlow logic and processing of the Development and Debug system.

Actual debug operation is executed by the Target system. Coordination is provided via communications between the Development and Target systems. That communication can take place via mediums, such as USB, Ethernet, FireWire etc. If the target is resident as a function within the same computer, direct data transfer is involved.

When debug is selected from the Development and Debug System main program, execution enters DebugFlow at block 300. Once in the debug function, the application developer can perform a number of operations, which allow him or her to probe the operation of the program. These debug functions are shown on the DebugFlow flow chart. The general program flow is a continuous loop that allows the selection and execution of the basic debug functions until the developer chooses to exit. The exit logic and execution is illustrated as blocks 340 and 342.

One of the key attributes of debugging is the setting and execution of program break points. The Development and Debug System allows the application developer to select any flow chart block for the placement of a break point. The break point selection is then communicated to the target system. During target system operation, the program will stop when it reaches the point in the programs where a break point is present and report its status to the Development and Debug System. Along with the ability to set a break point, the system allows a break point to be cleared. This is also communicated to the target system.

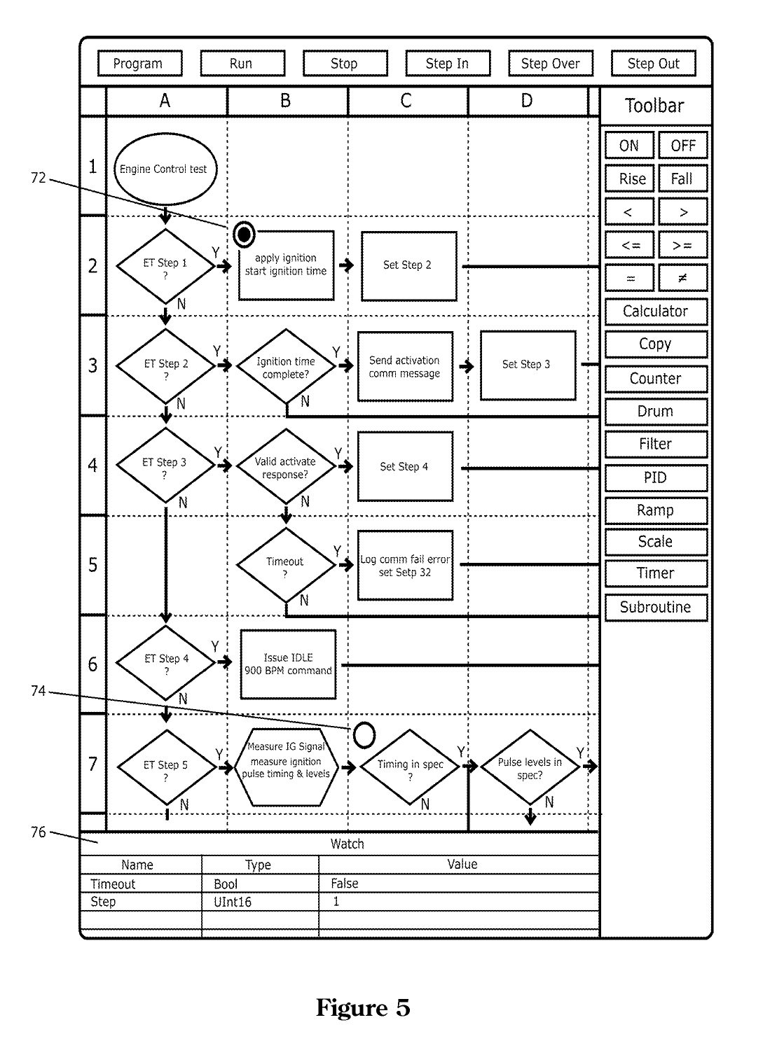

An illustration of breakpoint operation, from the perspective of the developer, is shown in FIG. 5. Items 72 and 74 are developer set breakpoints. Item 72 is colored in to indicate that the program is currently stopped at that point.

The logic for accomplishing the setting and clearing of break points is shown in FIG. 8 flow chart blocks 302 through 312. The DebugFlow allows the developer to select a program block, in 302, and select the toggling of the break point in 304. Blocks 306, 308, 310 and 312 handle the setting, clearing and updating of breakpoint settings.

A second important debug feature is the ability to view program data. The embodiment described herein allows the selectable option to display data associated with each flow chart block within the block. Additionally, program logic allows the developer to select any data for display in a watch window. FIG. 8 blocks 314 and 316 handle the editing of the watch window, by allowing the developer to add and delete selections. Blocks 332, 334, 336 and 338 contain the logic for reading and displaying data in the logic blocks and the watch window, as well as displaying operational status. A typical watch window is shown if FIG. 5, item 76.

The debug system gives the developer the ability to start and stop application execution, in the target system, at will. If break points are set and the application program flow reaches a break point, target execution will automatically stop. Manual starting and stopping at any time, would be initiated by a development and debug system start/stop select, similar to that show as items 62 nd 64 in FIG. 5. The logic for handling those selection are shown in flow chart FIG. 8, blocks 314 through 322.

Another key functional capability of the DebugFlow function is the ability for the developer to single step through program execution. Refer to FIG. 5. Single stepping in the execution of a single application flow chart block at a time, coupled with the updating of status and data execution at the end of the step's execution. In applications with sub-charts, there are three primary types of single step operations, as listed below.
Basic Single Step 66 steps through the execution of one program block. If the block is a sub-chart call, execution steps to the first block of the sub-chart. If the block is a return from a sub-chart, execution returns to the next block following the sub-chart call.
Single Step Over 68 treats sub-charts as a single program block. When the next program block is a sub chart call, single step over executes the entire sub-chart, along with any sub-charts called by that sub-chart, and stop execution at the logic block following the sub-chart call. If the next block is not a sub-chart call, Single Step Over operates identical to Basic Single Step.
Single Step Out 70 causes program execution to continue until the program returns from the current sub-chart. If not in a sub-chart, execution is identical to Basic Single Step.

Blocks 328 and 330 handle single step coordination with the Target system. The actual operation takes place in the target.

### Target System Operation

The following paragraphs discuss the logical operation of the main program and key functions of the target system. The target system is the actual test or simulation execution system. It can be a computer with input and output capability, or a stand alone embedded device with the necessary I/O, communications, CPU, memory and firmware. The following text describe the firmware (or software in a standard computer) that oversees, enables, downloads and provides supervisory control over the application developed from flow chart programming.

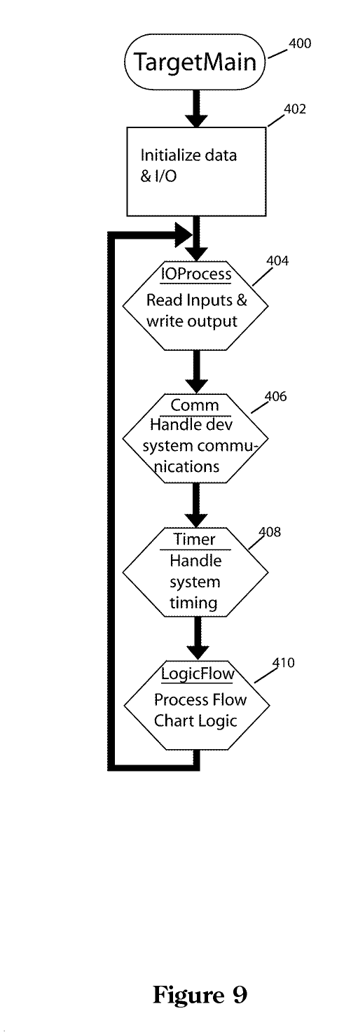

FIG. 9 defines the main program of an implementation of a target system for flow chart based automated test or simulation. The target program operates in a continuous loop. The main program handles the loop operation and calls subroutine functions to handle major operational details.

Target system program executions starts at FIG. 9 block 400. The first operation performed is the initialization 402 of all data and I/O in the target system.

In the illustrated implementation, the target system goes into a super loop operation. An alternate implementation might be the use of a multitasking operating system, which periodically switches between the key function tasks. In the implementation shown, each pass will read inputs, adjust output signals and perform other instrumentation activities in IOProcess, shown as block 404.

In block 406, communications is handled. Communications includes messages between the target system and the Development and Debug System. If there is other system communications capability, that communications is resident here, as well. Whenever executable code is downloaded from the Development and Debug System, the Communications function of the target system will handle the download and the set up for execution.

Block 408 handles system timing. This would include the time base for timer blocks in the application logic flow.

The heart of the target system operation is shown as the LogicFlow function in block 410. LogicFlow and its subroutines handle the execution and debug of the application executable code.

### Logic Flow Function of the Target System

FIG. 10 defines the LogicFlow logic and processing of the Target system. The LogicFlow function is the heart of the execution engine. It has supervisory functions which enable program debug from the development system. It also contains the logic execution for the compiled application flow chart blocks.

The LogicFlow function execution starts at block 500. The key execution block, function LogicSolve, called in block 526, performs all of the program logic execution. LogicSolve is described in more detail in subsequent pages.

The majority of the logic involved with LogicFlow has to do with the control of logic execution to allow for program debug. Blocks 502, 504, 506, 512 and 522 are all involved in controlling single step operations. If a single step operation is selected in debug mode, once the step is completed, block 522 detects completion and routes program flow to block 530. Block 530 saves the block number where the program flow stopped and the target system program returns to the main super loop. If the developer selects another step, logic blocks 502 and 504 detects it and block 506 restores the logic location to the saved location. The next step is then executed and the cycle repeats.

If a run or stop command is selected by the developer, block 518 detects the command and either sets the operating condition to free running or stops the program, depending on what was selected. Also note that a single step command places the target in run mode, until the condition is met. That condition, tested for in block 522 is one of the three step types defined earlier.

Blocks 512 and 514 show the operation of breakpoint entry and clearing. This logic also is executed for a single step, in order to place a breakpoint at the single step operation's destination.

If target is placed in run, or single step, mode, block 524 causes program flow to proceed to logic block solve, in block 526. After the logic block is solved, or executed, block 516 will advance the flow chart program to the next program block. Operation will repeat in a loop until either all of the program logic blocks have been executed 532, a break point 528 is reached or the single step operation 522 is completed.

Normal operation, when not in debug mode is the processing of all program logic blocks until completion. On the next pass through the target system, logic solve starts again, at the beginning of the flow chart program. Since application programs have previously been defined as being continuous loops, this constitutes a single application logic pass on each pass through the target system program.

An examination of the coordinated operation of LogicFlow, in conjunction with TargetMain and the development system's DebugFlow should provide greater perspective on system operation and the particular operation of LogicFlow.

What is claimed is:

1) A development and debug system operating on a computer for creating a graphically flow chart illustrated program which can be subsequently compiled to code that directly represents the flow chart logic and is executable as an automated test program or automated simulation program, comprising:
a) a program constructor operable to enable the application developer to select, configure and connect a plurality of standard flow chart block elements together in a manner to construct a logical program.
b) a program editor operable to enable the application developer to add, delete, rearrange and reconfigure flow chart block elements to modify program logic.
c) a data structure for storing program logic, in the computer's file system, which fully encapsulates both the configured details of each of the flow chart block elements in the flow chart program and the program flow between flow chart blocks.
d) standard, selectable and configurable flow chart blocks for operations including, but not limited to processing, performing mathematical operations, making decision, filtering data, performing statistics, sequencing, timing, communications, input/output processing and flow control.

2) The system of claim 1, wherein the program constructor comprises flow chart block configurator elements which allow the application developer to completely delineate the operation of the flow chart block without computer language program code.

3) The system of claim 1, further comprising a compiler associated with the flow chart constructor and editor that creates flow chart code which is executable by a target execution engine.

4) A method of claim 1, further providing for constructors for the creation of separate flow chart program modules, or sub-charts that can be called by the main program flow chart, or by other separate sub charts, for execution at the point defined by the application developer, comprising:
a) a separate application memory space to be used for program data that is associated directly with the particular separate program or sub-chart.
b) a method that allows the application programmer to define data that can be transferred to and from the sub-chart.
c) a distinct separation from all other routines which allow the sub-chart to be transferred to other application programs for reuse.

5) A method of claim 1 for providing debugging control, data collection and program execution inspection from the development and debug system, further comprising:
a) a method wherein the application developer can select individual program flow chart function blocks that if reached in program execution will cause execution to stop.
b) a method wherein the debugging method coordinates with the execution engine of claim 8 to collect status information and data values during debug program execution and while execution is stopped.
c) a method to coordinate with the execution engine of claim 8 to start and stop program execution.
d) a method to coordinate with the execution engine of claim 8 to step execution through flow chart blocks, one at a time, under the control of the application developer.
e) a method to coordinate with the execution engine of claim 8 to enable the application developer to step program execution into flow chart blocks of sub-charts, called by the program or sub-chart whose execution is being stepped through.
f) a method to coordinate with the execution engine of claim 8 to enable the application developer to step through the execution of an entire sub chart called by the program or sub chart as a single step.
g) a method to coordinate with the execution engine of claim 8 to enable the application developer to step out of a sub chart called by the program or sub-chart entailing execution of all program blocks through the sub chart return statement.
h) A method to display program execution data and status information collected from the execution engine of claim 8 within the graphical flow chart blocks displayed on the flow chart development system of claim 1.
i) A method for displaying information and data selected by the application developer.

6) A method, of claim 1, that provides a mechanism for the development and debug system to deploy execution code on any target test system that is designed to process and execute the compiled object code, generated by the development and debug system.

7) A mechanism for programming or otherwise transmitting compiled executable object code, generated according to claim 3, to the target execution environment, for ultimate independent operation.

8) A run time execution engine that executes or supervises the execution of code generate by the compiler of claim 3.

9) A method of claim 8 comprising the execution engine functional capability to automatically transfer program control from the calling chart to a called sub-chart and return program control to the calling chart at the completion of sub chart execution, comprising:
a) the execution engine capability for each sub chart to transfer control to sub-charts, thereby enabling multiple levels of sub-chart execution.
b) a method for transferring data and data references from one chart to its called sub chart.
c) the capability for a sub-chart, at any level, to access data in a common pool of global data.

10) A method of claim 8 for controlling the flow chart execution flow and collecting data for program debug purposes, consisting of:
a) a method wherein the execution engine will respond to requests from the development and debug system to stop execution when a selected flow chart function block is reached.
b) a method wherein the execution engine of claim 4 collects status information and data values during debug program execution and while execution is stopped and transmits said information and data to the development and debug system.
c) a method to respond to requests from the development and debug system of claim 1 to start and stop program execution.
d) a method to execute commands from the development and debug system of claim 1 to step execution through flow chart blocks, one at a time.
e) a method to execute commands from the development and debug system of claim 1 to step program execution into flow chart blocks of sub-charts, called by the program or sub-chart whose execution is being stepped through.
f) a method to execute commands from the development and debug system of claim 1 step over a sub chart called by the program or sub chart whose execution is being stepped through by executing the logic of the entire flow chart as a single step.
g) a method to execute commands from the development and debug system of claim 1 step out of a sub chart called by the program or sub-chart whose execution is being stepped through by executing all sub chart logic through the return statement as a single step.
